(19) United States
(12) Patent Application Publication
(10) Pub. No.: US 2026/0160964 A1
(43) Pub. Date: Jun. 11, 2026

(54) Pluggable Transceiver and Receptacle Modules with High Pin Count Electrical Contact Array

(71) Applicant: PicoJool, Inc., Palo Alto, CA (US)

(72) Inventors: Albert T. Yuen, Palo Alto, CA (US); Paul K. Rosenberg, Santa Cruz, CA (US)

(73) Assignee: PicoJool, Inc., Palo Alto, CA (US)

(21) Appl. No.: 19/412,812

(22) Filed: Dec. 8, 2025

Related U.S. Application Data
(60) Provisional application No. 63/730,456, filed on Dec. 11, 2024.

(51) Int. Cl. G02B 6/42

(52) U.S. Cl. CPC G02B 6/4278; G02B 6/4277; G02B 6/428; G02B 6/4284

(57) ABSTRACT

A pluggable transceiver has an outer casing to be attached to a networking cable and to be plugged into a receptacle, and a bottom surface exposing a two-dimensional array of electrical contact pads. The contact pads are electrically coupled with power supplies, ground references, and data signals received from and/or transmitted to the networking cable. Parasitic properties of the electrical contact pads and any devices, circuits, tracks, or wires inside the module are sufficiently small to support data signal bandwidths exceeding 100 gigabits per second. A receptacle that can receive the pluggable transceiver module includes an EMI cage, an LGA socket, and a transfer subsystem that moves the pluggable transceiver vertically down so that the electrical contact pads are pressed into direct contact with the LGA socket.

### REFERENCES

This application claims priority from U.S. provisional patent application ser. no. 63/730,456, entitled “Pluggable Module with 2D Electrical Contact Array,” filed on Dec. 11, 2024.

### BACKGROUND

### Technical Field

The disclosed implementations relate to transceivers in general, and to small-form-factor pluggable transceivers and receptacles for high-speed data communication applications in particular.

### Context

Pluggable transceivers and receptacle modules with a small form factor allow users to conveniently tailor their data center interconnection arrangements to suit requirements in the field. Network interfaces include a hot-swappable transceiver and socket or receptacle used to connect network devices like firewalls, switches, routers, hubs with fiberoptic or copper cables. The transceiver is located inside the pluggable module at the end of a networking cable and plugs into the receptacle module in the network device.

Various standards exist, including small form-factor pluggable (SFP), SFP+ and SFP28 (faster versions), and quad SFP (QSFP) and octal SFP (OSFP), offering four and eight high-speed “lanes”, respectively. Within the standards, sub-standards exist, including QSFP-DD (for double density), and others. Standards may be maintained involving multi-source agreements (MSAs), the Small Form Factor (SFF) Committee, and official standards bodies like the Institute of Electrical and Electronics Engineers (IEEE).

Copper-based QSFP modules are typically used for short-distance transmission, while modules based on the use of edge-emitting lasers may be used for applications requiring longer reach. The electrical input/output ports or contacts of such a transceiver module are arranged side by side along at the top and/or bottom edge of a printed circuit board (PCB) protruding out of the module housing, to removably mate with a corresponding linear array of electrical contacts on a socket at the network device. For example, the QSFP standard (see the “Quad Small Form-factor Pluggable (QSFP) transceiver Specification, Rev. 1.0,” issued in November 2006 by the SFF Committee) specifies a layout of 19 contact pads at the bottom of the PCB edge and another 19 contact pads at the top of the PCB edge for a total of 38 contact pads. The QSFP-DD MSA (“QSFP-DD/QSFP-DD800/QSFP-DD1600 Hardware Specification for QSFP DOUBLE DENSITY 8X PLUGGABLE TRANSCEIVERS,” Rev 7.1 of Jun. 25, 2024) specifies a total of 76 contact pads at the top and bottom of the PCB edge.

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

### BRIEF DESCRIPTION OF THE DRAWINGS

The technology will be described with reference to the drawings, in which:

FIG. 1 shows a perspective view 100 of a pluggable transceiver 110, with a cable 130 protruding from one end, and an edge connector PCB 120 protruding from the other end.

FIG. 2 shows a QSFP interface 200, including pluggable transceiver 110, receptacle 150, and networking device PCB 175 in some detail.

FIG. 3 shows a simplified example of a land grid array (LGA 300) and part of a socket 350 that may receive LGA 300 to provide electrical interconnection.

FIG. 4 illustrates a simplified lateral cross-sectional view of an example transceiver module 400 with the LGA 300 and a receptacle module 450 with socket 350 of FIG. 3.

FIG. 5 illustrates a printed circuit board PCB 575 with example receptacle 550 and partially inserted pluggable transceiver 500.

FIG. 6 shows the transceiver fully inserted and locked in its down position.

FIG. 7 illustrates an optical implementation, where the pluggable module 700 is at the end of a fiberoptic cable 730 with multiple fibers 731.

In the figures, like reference numbers may indicate functionally similar elements. The systems and methods illustrated in the figures—and described in the Detailed Description below—may be arranged and designed in a wide variety of different implementations. Neither the figures nor the Detailed Description are intended to limit the scope as claimed. Instead, they merely represent examples of different implementations.

### DETAILED DESCRIPTION

Pluggable transceivers with a small form factor allow users to conveniently tailor their data center interconnection arrangements to suit requirements in the field. The current state-of-the-art pluggable transceiver is known by the acronym QSFP, meaning quad small form-factor pluggable, as it provides 4 high-speed lanes, though versions with 8 high-speed lanes are recently becoming available.

Copper-based QSFP modules are typically used for short-distance transmission, while modules based on the use of edge-emitting lasers are used for applications requiring longer reach. The electrical input/output ports or contacts of such a transceiver module are arranged side by side along an edge of the module housing, to removably mate with a corresponding linear array of electrical contacts on a socket on or attached to the destination line card.

A significant performance issue affecting both types is that with four (or even eight) lanes, the total bandwidth is correspondingly limited. At a typical capacity of 100 Gbps per lane, the maximum achievable bandwidth is only 400 Gbps (or 800 Gbps). Data centers and HPC (high performance computing) applications are demanding ever higher bandwidths to serve their computing and communication requirements. However, adding more lanes is difficult, as the edge connector inside the receptacle module would need to deal with increasingly long distances of connections between its contact pads and corresponding metal tracks on the network device's internal PCB on which the receptacle is mounted. These long connections introduce parasitic inductances that limit the signals'speed and parasitic capacitances that impact signal integrity.

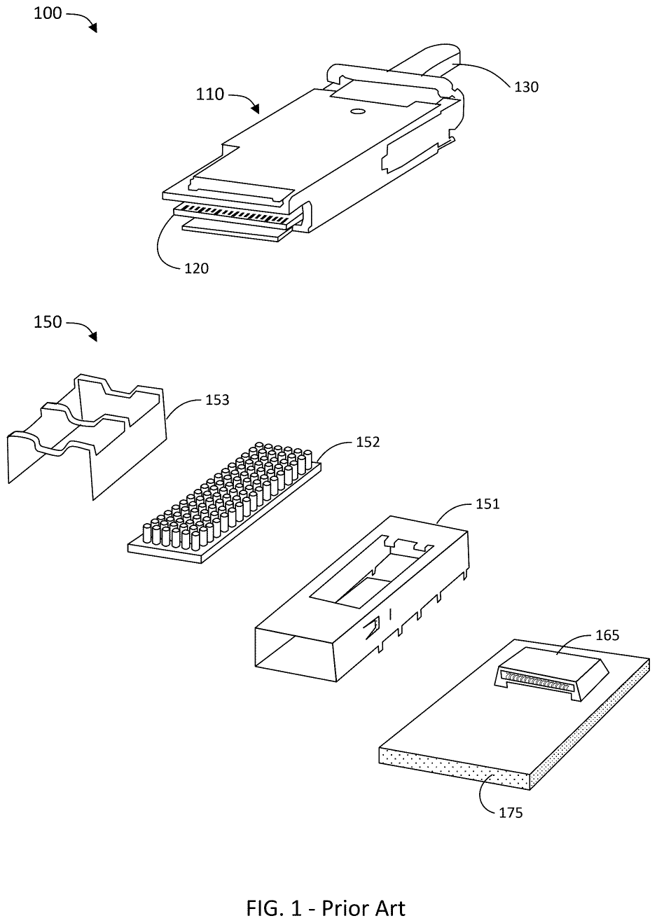

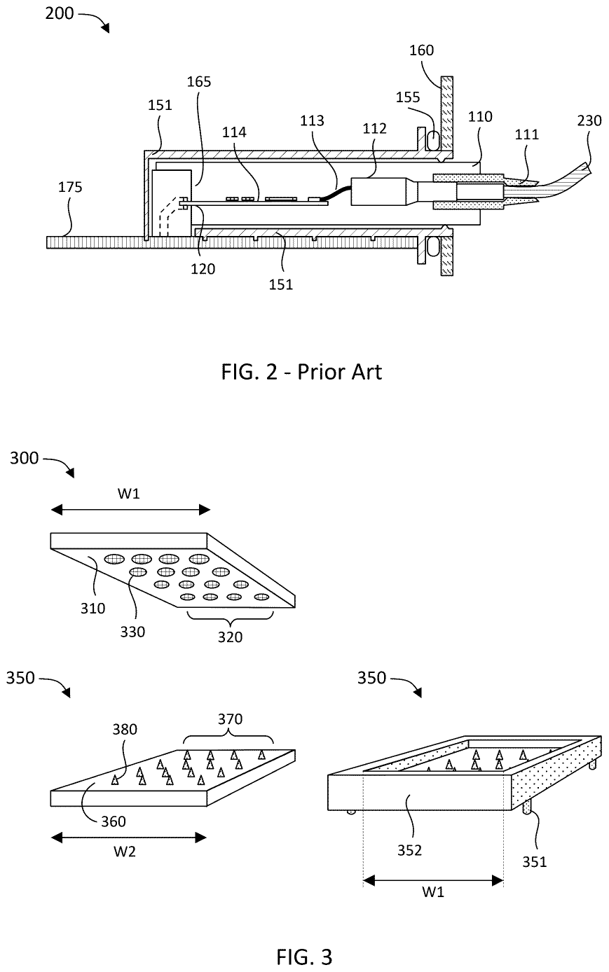

The state-of-the-art prior to the technology disclosed herein may be understood by reference to FIGS. 1-2. FIG. 1 shows a perspective view 100 of a pluggable transceiver 110, with a cable 130 protruding from one end, and an edge connector PCB 120 protruding from the other end. The receptacle 150 is mounted on networking device PCB 175 and may include edge connector 165, an electromagnetic interference cage (EMI cage 151), a heatsink 152, and a bracket 153. Optional heatsink 152 may be located below bracket 153 and on top of EMI cage 151, which is mounted to networking device PCB 175 over edge connector 165.

Pluggable transceiver 110 may then be inserted (edge connector PCB 120 first) into the open end of EMI cage 151, and edge connector PCB 120 may slot into edge connector 165 to provide electrical connections for signals exchanged between cable 130 and networking device PCB 175.

FIG. 2 shows the QSFP interface 200, including pluggable transceiver 110, receptacle 150, and networking device PCB 175 in more detail. EMI cage 151 is mounted on networking device PCB 175 and may have line card faceplate 160 with a rubber ring or gasket 155 for smooth mechanical interfacing. Pluggable transceiver 110 is plugged into EMI cage 151. It is coupled with an optical cable 230, protected by ferrule 111. Optical cable 230 is coupled with the electrical-to-optical interface assembly 112. A flex cable 113 provides electrical interconnections between electrical-to-optical interface assembly 112 and transceiver circuit board 114. Edge connector 165 couples transceiver circuit board 114 with networking device PCB 175.

The technology disclosed herein parts with the limitations imposed by the “lane approach” of conventional technologies by working with a two-dimensional contact grid instead of an edge connector and introducing mechanical adaptations to secure reliability.

### Terminology

As used herein, the phrase “one of” should be interpreted to mean exactly one of the listed items. For example, the phrase “one of A, B, and C” should be interpreted to mean any of: only A, only B, or only C.

As used herein, the phrases “at least one of” and “one or more of” should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” (or “contains”) certain features, the presence of any additional features is excluded.

The term “coupled” is used in an operational sense and is not limited to a direct or an indirect coupling. “Coupled to” is generally used in the sense of directly coupled, whereas “coupled with” is generally used in the sense of directly or indirectly coupled. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The terms “interconnect” and “interconnection” are used to indicate (an) electrical coupling or (a) photonic coupling, which may be direct or indirect.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 20% of an indicated value, unless explicitly specified otherwise.

The following terms or acronyms used herein are defined at least in part as follows:
“CPU”—central processing unit
“CQW”—quantum well modulator
“Datum”—in the context of a QSFP specification, “datum” refers to a reference point or a zero-point used for measurements of a specific dimension on the module or cage. It is a geometric feature that allows for precise alignment and manufacturing, ensuring that all components and connections are built to a common standard for proper fit and function.
“EIC”—electronic IC
“EMI”—electromagnetic interference
“HPC”—high-performance computing
“IC”—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
“IEEE”—the Institute of Electrical and Electronics Engineers
“LGA”—land grid array—an interface system, most often used for CPUs, in which the socket has pins and the device has “lands”, pads on which the socket pins land, instead of the other way around such as pin grid arrays (PGAs), in which the device has pins and the socket (or PCB) has holes in which the pins are inserted. In both systems, the pins are arranged in a grid, which makes it possible to have high numbers of interconnections. Because pins are tiny, they can easily be damaged. For this reason, it can be safer to have the pins in the socket rather than on a device that may be handled often.
“MSA”—multi-source agreement
“OSFP”—octal small form-factor pluggable
“PCB”—printed circuit board
“PGA”—pin grid array
“PIC”—photonics integrated circuit
“QCSE”—quantum-confined start effect
“QSFP”—quad small form-factor pluggable
“SFF”—small form factor
“SFP”—small form-factor pluggable
“TSV”—through-semiconductor-via
“VCSEL”—vertical-cavity surface-emitting laser
“Gbps”—gigabit per second
“QSFP”—quad small form-factor pluggable
“SFP”—small form-factor pluggable, a compact, hot-pluggable network interface module format used for both telecommunication and data communications applications (Wikipedia). An SFP interface on networking hardware is a modular slot for a media-specific transceiver, such as for a fiber-optic cable or a copper cable.

### Implementations

FIG. 3 shows a simplified example of a land grid array (LGA 300) and part of a socket 350 that may receive LGA 300 to provide electrical interconnection. The top surface 310 of LGA 300 exposes a two-dimensional array 320 of “lands” or electrical contact pads 330. The bottom surface 360 of socket 350 exposes a two-dimensional array 370 of electrical contacts 380. In this simplified example, LGA 300 and socket 350 have 4×4 arrays of pads/contacts, but other implementations may have any number of pads and contacts, and practical implementations have much higher numbers of contact pads. For example, an implementation may have 16 rows and 16 columns of contact pads, or 256 pads, or 48 rows and 24 columns of totally 1152 contact pads. The electrical contacts 380 may be of the types used with land grid arrays, for example round or triangular and flexible or stiff, or of any similar type. Contacts may, for example, have a height between 0.4 and 4 millimeters, and a pitch of 0.5 to 2 millimeters.

The electrical contact pads 330 and electrical contacts 380 are used for transferring power from a networking device to a pluggable transceiver module. Therefore, a first portion of the electrical contact pads is configured to electrically couple with one or more power supplies and ground references, and a second portion of the electrical contact pads is configured to electrically couple with data signals received from and/or transmitted to the networking cable attached to the pluggable transceiver module. To allow for a high bandwidth of the data signals, the number of contact pads may be high compared with the number of contacts (76) that can be reached with, for example, the edge connector of a QSFP system. For example, the number of contact pads may be 256 or higher. Further, to achieve the high data bandwidth, parasitic properties (parasitic inductances, parasitic capacitances, and parasitic resistances) of the electrical contact pads and any devices, circuits, tracks, and/or wires inside the pluggable transceiver module are small enough to allow a bandwidth of the data signals of, for example, over 100 gigabits per second. A current state-of-the-art implementation may achieve a bandwidth of 1600 or 3200 gigabits per second.

The width W2 of socket 350 can be as small as the width W1 of LGA 300 and still allow the desired number of electrical connections to be made. In some implementations, socket 350 may have a machined plastic (or other material) alignment frame 352 that allows LGA 300 to perfectly align, and at the bottom it may have socket-to-PCB alignment pins 351 to precisely secure its place on a networking device PCB, or other PCB.

For simplicity of the presentation, FIG. 3 does not show any mechanical parts, the receptacle's EMI cage or any of the other electrical circuits and components that are part of the device or the socket. Some of those are discussed later in this document. In implementations of the technology disclosed, LGA 300 is integrated into the pluggable transceiver, whereas socket 350 is used in the receptacle module.

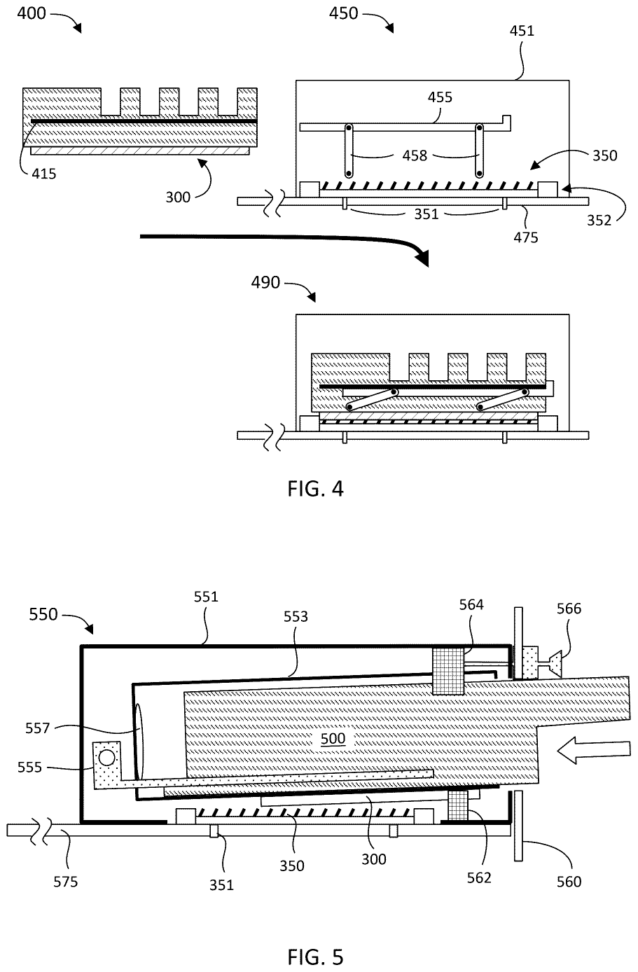

FIG. 4 illustrates a simplified lateral cross-sectional view of an example transceiver module 400 with the LGA 300 and a receptacle module 450 with socket 350 of FIG. 3. The land grid array (300) at the bottom of transceiver module 400 has no protruding parts and can therefore be handled relatively safely. Socket 350 may be inside EMI cage 451 and mounted on networking device PCB 475, so that its vulnerable contacts are mechanically shielded from most risks. Socket 350 may have alignment frame 352, and at its bottom it may have socket-to-PCB alignment pins 351 to precisely secure its place on networking device PCB 475. LGA 300 and socket 350 may be brought into electrical and mechanical contact with each other. The illustration exaggerates the protrusion of the LGA pin-type contacts beyond the socket surface for clarity. Shapes and dimensions in this figure merely illustrate one possible example arrangement. Many other arrangements are possible and can be readily envisaged.

FIG. 4 also illustrates an example transfer subsystem and an example insertion procedure. The transfer system includes a slide feature 415 on transceiver module 400 that allows it to rest on a matching guide rail 455 in receptacle module 450. Guide rail 455 is suspended on rotatable arms 458 that can move guide rail 455 to the right (towards the back of the receptacle) and down in an arc motion when pluggable transceiver module 400 is inserted. The thick arrow indicates the movement of pluggable transceiver module 400 as it is being inserted into receptacle module 450, moving to the right until it is fully resting on guide rail 455 and then in an arc motion down onto the contact pins of socket 350. The final situation is shown in view 490, where the contact pads are resting on the contacts. The module is held in place by a latch or latching sub-system (not shown) as it moves down. When the lowest position is reached, the latch or latching sub-system may operate to press the module's LGA pads securely against the contacts of socket 350 to achieve the desired connectivity. The transfer subsystem is inside EMI cage 451 and is configured to receive transceiver module 400 and securely place the two-dimensional array of electrical contact pads at the bottom of the pluggable transceiver module on the two-dimensional array of electrical contacts. The transfer subsystem moves the pluggable transceiver module vertically down after it is inserted in the front opening and adequate mechanical engagement and pressure is achieved between the pluggable transceiver module and the transfer subsystem. In this way, the two-dimensional array of electrical contact pads at the bottom of the pluggable transceiver module is pressed into direct contact with the two-dimensional array of electrical contacts in the socket.

There are many ways to implement the disclosed technology. Some non-limiting examples include the following:
Example 1. The transceiver module is pushed along between a pair of horizontal guide rails into an opening in an EMI cage attached to a line card. As the module is pushed inward, the guide rails move downward towards the top surface of the line card, countering a spring force that is lifting the guide rail upwards, until contact is made between the module's LGA pads and the socket. A latch helps to secure the module in place during the motion and at its destination. Once released, springs in the guide rails lift the module up and away from the socket and the module is free to be pulled out.
Example 2. The transceiver module is pushed into the EMI cage opening above the networking device PCB. Once it has reached the desired predetermined horizontal position, a latch handle on the outside of the module is either lifted upward or pushed downward according to different implementations, in each case causing a structure to push down on the top surface of the module against a spring force, till it reaches the line card and makes the desired firm contact between the transceiver's pads and the socket. The opposite sequence occurs to release the module, operating the latch handle in the opposite direction to lift the structure, allowing the spring force to push the pluggable module up to the level at which it may be pulled out of the EMI cage.

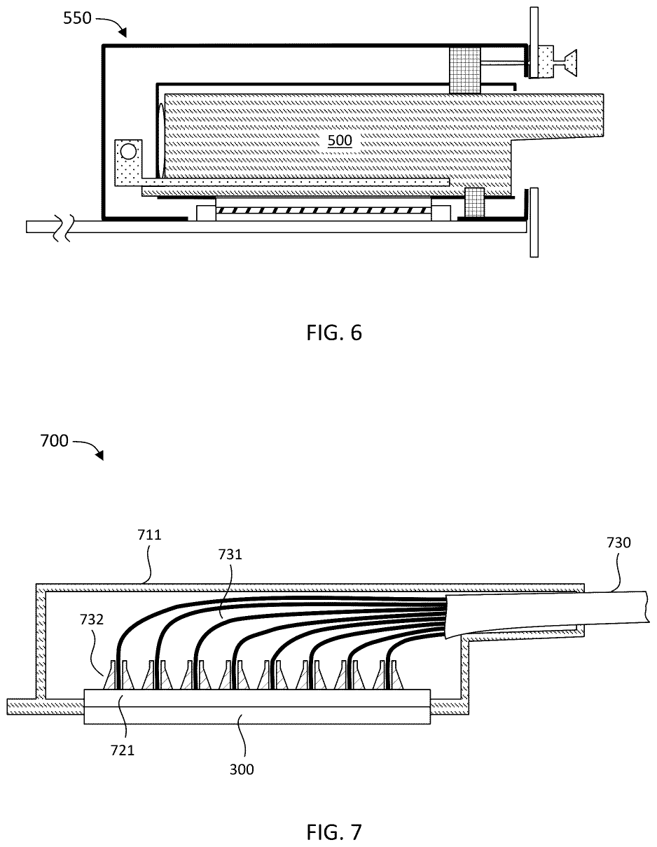

FIG. 5 illustrates a printed circuit board PCB 575 with example receptacle 550 and partially inserted pluggable transceiver 500. In this implementation, pluggable transceiver 500 is inserted at a small angle, for example between one (1) and five (5) degrees (an angle of 2 degrees has been drawn). Once fully inserted, it can pivot down so that its contact pads substantially land vertically on the receptacle's contacts, and the transceiver is latched in place. Receptacle 550 includes EMI cage 551, carriage 553 with depth control feature 557, depth latch 562 and vertical force feature 564 with insertion actuator 566. EMI cage 551 and socket 350 are mounted on PCB 575, and EMI cage 551 encloses socket 350 to reduce electromagnetic interference. Carriage 553 can pivot around pivot mechanism 555. Implementations may have further features such as guide pins on socket 350 to enforce accurate alignment of LGA 300 at the bottom of pluggable transceiver 500; a spring capture in pivot mechanism 555; heatsink fins at pluggable transceiver 500 to deal with dissipated power; and a face plate 560 at the front of the receptacle. FIG. 6 shows the transceiver fully inserted and locked in its down position.

FIG. 7 illustrates an optical implementation, where the pluggable module 700 is at the end of a fiberoptic cable 730 with multiple fibers 731. Pluggable module 700 includes outer casing 711, LGA 300, photonics IC 721, and fiber alignment features 732. The fiber alignment features 732 align the ends of fibers 731 with vertical-cavity surface-emitting lasers (VCSELs), other modulators, and/or photodetectors integrated into photonics IC 721 to effectively transfer light signals between fibers 731 and photonics IC 721. Photonics IC 721 can be made in any suitable semiconductor technology, including GaAs, Si, InP, SiGe, Ge, diamond, and others. VCSELs generate monochromatic light (light of a single wavelength) and are also able to modulate signals onto the light and emit the light vertically. Photonics IC 721 may also use other modulators to modulate light from any light source, including horizontal modulators. Photodetectors may also be either vertical or horizontal, and interfacing between horizontal devices and the fibers may require the use of couplers, such as grating couplers. Couplers may transmit vertically, or under an angle. In the latter case, fiber alignment features 732 may align fibers 731 at a matching angle. Fiber alignment features 732 may align single fibers, or multiple fibers in a row, for example matching a row of contact pads on LGA 300. Photonics IC 721 may route electric power and signals from its top and from internal layers to its bottom using through-semiconductor-vias (TSVs) to connect with LGA 300. In some cases, the contact pads of the LGA are directly placed at the bottom of photonics IC 721, so that photonics IC 721 and LGA 300 are a monolithic semiconductor device. In other cases, photonics IC 721 acts as an interposer, transmitting and routing power and signals between locations at its top and the LGA locations at its bottom. In yet other cases, LGA 300 is an electronic IC (EIC) with integrated functions to process signals, and the land grid array at its bottom to interface with socket 350.

The technology described herein addresses the problem of bandwidth bottlenecks by providing a higher number of high speed-lanes than is practically feasible with the edge pluggable QSFP platform in widespread use today. It replaces the latter's one-dimensional edge connector with a two-dimensional array of electrical contacts, one on the pluggable module and one on the line card, along with the mechanical sub-systems that enable their convenient, intuitive use.

### Considerations

We describe various implementations of a pluggable transceiver module and a receptacle module.

The technology disclosed can be practiced as an apparatus or method. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Different semiconductor materials can be employed, such as silicon, germanium, SiGe, GaAs, InP, GaN, SiC, graphene, diamond, etc.

Different integration technologies can be used for a PIC, such as silicon photonics, InP, silicon nitride, hybrid and heterogeneous integration technologies, etc. Implementations may use different technologies for optical modulators, including Mach-Zehnder, microring resonator, SiGe electroabsorption modulator, Franz-Keldysh electroabsorption modulators, a quantum-confined start effect (QCSE) electroabsorption modulator, a quantum well modulator (CQW), etc. Different alternative layouts can be employed for an AWGR implementation, such as a combination of interconnected multiplexers and demultiplexers, echelle grating structures, etc. PICs may operate at any wavelength band. Any type of laser source can be employed, like distributed feedback lasers, laser diodes, hybrid integrated InP lasers, multiwavelength laser sources, microcomb light generator sources, etc. Different technologies can be implemented for photodiodes, such as SiGe electro-absorption photodiodes, InP photodiodes, avalanche photodiodes, etc.

It will also be appreciated that one or more of the elements depicted in the drawings/figures can also be implemented in a more separated or integrated manner or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

1. A pluggable transceiver module, comprising:
an outer casing configured to be attached to a networking cable and configured to be plugged into a receptacle; and
a bottom surface of the outer casing exposing a two-dimensional array of electrical contact pads;
wherein:
a first portion of the electrical contact pads is configured to electrically couple with at least one power supply and one ground reference;
a second portion of the electrical contact pads is configured to electrically couple with data signals received from and/or transmitted to the networking cable; and
parasitic properties of the electrical contact pads and any devices, circuits, tracks, and/or wires inside the pluggable transceiver module are small enough to allow a bandwidth of the data signals of over 100 gigabits per second.

2. The pluggable transceiver module of claim 1, wherein the two-dimensional array of electrical contact pads is a land grid array (LGA).

3. The pluggable transceiver module of claim 1, wherein a number of electrical contact pads is 256 or higher.

4. The pluggable transceiver module of claim 1, wherein the bottom surface of the outer casing includes one or more holes configured to receive alignment pins of a socket exposing a two-dimensional array of electrical contacts matching the two-dimensional array of electrical contact pads.

5. The pluggable transceiver module of claim 1, wherein the bottom surface of the outer casing includes a hole configured to receive a depth latch.

6. The pluggable transceiver module of claim 1, further comprising a slide feature that allows the pluggable transceiver module to rest on a matching guide rail in the receptacle.

7. The pluggable transceiver module of claim 1, further comprising a heatsink.

8. The pluggable transceiver module of claim 1, further comprising a photonics integrated circuit (PIC) including at least one of an array of vertical-cavity surface-emitting lasers (VCSELs) or an array of photodetectors configured to be optically coupled with fibers from the networking cable, and wherein the PIC uses through-semiconductor-vias (TSVs) to electrically couple the VCSELs and/or photodiodes with the two-dimensional array of electrical contact pads.

9. A receptacle for a pluggable module, comprising:
a cage for reducing electromagnetic interference;
a socket exposing a two-dimensional array of electrical contacts configured to mate with contact pads on a two-dimensional array of electrical contact pads at a bottom of a pluggable transceiver module; and
a transfer subsystem to receive the pluggable transceiver module and securely place the two-dimensional array of electrical contact pads at the bottom of the pluggable transceiver module on the two-dimensional array of electrical contacts.

10. The receptacle for the pluggable module of claim 9, wherein:
the socket exposing a two-dimensional array of electrical contacts is an LGA socket.

11. The receptacle for the pluggable module of claim 9, wherein:
the transfer subsystem to receive the pluggable transceiver module includes a guide rail suspended on rotatable arms that can move the guide rail towards a back of the receptacle and down in an arc motion when the pluggable transceiver module is inserted.

12. The receptacle for the pluggable module of claim 9, wherein:
the transfer subsystem to receive the pluggable transceiver module includes a carriage that can pivot around a pivot mechanism and that is configured to receive the pluggable transceiver module at an angle and to rotate it down when fully inserted, so that the two-dimensional array of electrical contact pads at the bottom of the pluggable transceiver module securely lands on the two-dimensional array of electrical contacts.

13. The receptacle for the pluggable module of claim 12, wherein the angle is between one (1) and five (5) degrees.

14. The receptacle for the pluggable module of claim 9, wherein the transfer subsystem to receive the pluggable transceiver module comprises at least one spring.

15. The receptacle for the pluggable module of claim 9, wherein adequate mechanical engagement and pressure to achieve direct contact between the contact pads and the electrical contacts are provided using a latch included in the transfer subsystem.

16. A networking device, comprising:
a printed circuit board (PCB);
a socket mounted on the PCB and exposing a two-dimensional array of electrical contacts configured to mate with contact pads on a two-dimensional array of electrical contact pads at a bottom of a pluggable transceiver module;
a cage for reducing electromagnetic interference mounted on the PCB and enclosing the socket, wherein the cage has a front opening for receiving the pluggable transceiver module; and
a transfer subsystem inside the cage to receive the pluggable transceiver module and securely place the two-dimensional array of electrical contact pads at the bottom of the pluggable transceiver module on the two-dimensional array of electrical contacts, wherein the transfer subsystem is configured to move the pluggable transceiver module vertically down after it is inserted in the front opening and adequate mechanical engagement is achieved between the pluggable transceiver module and the transfer subsystem, such that the two-dimensional array of electrical contact pads at the bottom of the pluggable transceiver module is pressed into direct contact with the two-dimensional array of electrical contacts in the socket.
